(19) United States
(12) Patent Application Publication
(10) Pub. No.: US 2011/0007986 A1
(43) Pub. Date: Jan. 13, 2011

(54) Multi Compartment Trash and Recycling Bag and Method of Manufacturing the Same

(76) Inventors: John Graylin EYTCHESON, San Antonio, TX (US); Dicie Lee EYTCHESON, San Antonio, TX (US)

Correspondence Address: KAMMER BROWNING PLLC, 7700 BROADWAY, SUITE 202, SAN ANTONIO, TX, 78209, US

(21) Appl. No.: 12/796,529

(22) Filed: Jun. 8, 2010

Related U.S. Application Data
(60) Provisional application No. 61/185,078, filed on Jun. 8, 2009.

(51) Int. Cl. B65D 30/22; B65H 35/04; B31B 1/14

(52) U.S. Cl. 383/38; 242/526.1; 493/223

(57) ABSTRACT

A multi-compartment plastic bag suitable for collecting and retaining a quantity of refuse and a quantity of recyclable items. The multi-part bag provides longitudinal compartments for the receipt of refuse or recycling. The longitudinal compartments are each sealed on three sides with a fourth (top) edge open for the insertion of refuse/recycling. The multi-compartment bag is initially constructed as a single unit and may be separated into the multiple components along one or more perforated mid-seams. Grab handles may be formed near the upper edge through perforated cutouts. The multi-compartment bag is designed to be used in standard single compartment trash receptacles. The construction of the bag lends itself to manufacture in a continuous multilayer sheet with longitudinal sealed seams along each edge of the multilayered sheet and at least one partial longitudinal sealed seam along an interior line or mid-seam of the multi-layered sheet. The mid-seam may be perforated for the later separation of the multiple bag components. Grab handle perforations (in the nature of a partial or complete oval or circle) may be made at the appropriate intervals.

### CROSS REFERENCES TO RELATED APPLICATIONS

This application claims the benefit under Title 35 United States Code §119(e) of U.S. Provisional Application 61/185,078 filed Jun. 8, 2009, the full disclosure of which is incorporated herein by reference.

### BACKGROUND OF THE INVENTION

1. Field of the Invention

The present invention relates generally to containers for the collection and retention of refuse and recyclable items. The present invention relates more specifically to plastic bags configured to collect and separately retain both disposable refuse and recyclable items.

2. Description of the Related Art

Efforts have been made in the past to accommodate the ever growing need to collect and contain both refuse that requires disposal as trash and recyclable items that would preferably be kept out of landfills. The daily consumption of products, packaging, and other materials in the typical home or business results in a significant quantity of both recyclable material and non-recyclable refuse. In most cases, efforts in the past to provide for the collection and retention of all of these materials on a daily basis has been directed to the use of separate rigid containers that may or may not be intended for use with plastic liners (bags). Many specialized recycling containers have been created, some of which have single compartments and are intended for use in multiple units, stacked or connected side by side. Many designs provide special multi-compartment rigid containers that again, may or may not be intended for use with plastic liners. In almost every instance, however, the recycling container designs are intended to replace the standard waste basket or to supplement it. In either case, the consumer is forced to purchase a new container to sort recycling apart from refuse.

Every home and business has one or more refuse containers. The process for collecting, temporarily retaining, and then disposing of refuse using these waste baskets is well established. Recycling is becoming ever more important on a daily basis, and yet other than by purchasing new containers to serve for recycling collection, the consumer is unlikely to make an effort to separate out recyclables from trash and ends up collecting both together in the existing waste baskets. Purchasing a new container to hold recycling represents not only an additional cost to the consumer but perhaps, more importantly, represents something that takes up more space in the home or office. In many of the common locations where waste baskets and refuse containers are kept there is little or no additional room for a separate recycling container.

Some effort has been made to create multi-compartment bags, some of which are designed to accommodate the separation of refuse from recyclables. In every case, however, these past efforts have sacrificed ease of manufacture for ease of use. The manner in which these multi-compartment bags are constructed allows them to be used, for example, in side by side containers or in containers with multiple rigid compartments, but this typically results in the requirement that the bags be custom manufactured one at a time in an expensive process that results in an expensive product. In the end, these “customized” multi-compartment bags or liners are designed to fit a specific rigid container and are less than versatile when it comes to being used with a variety of different trash containers.

It would be desirable, therefore, if a product were available that solved the problem of simultaneously collecting and retaining refuse and recyclables without the need to purchase new containers. It would be desirable if such a product took up no more space than the existing waste baskets or refuse containers that are currently in use. It would finally be desirable is such a product was easy to manufacture in large quantities and was therefore relatively inexpensive.

### SUMMARY OF THE INVENTION

It is therefore an object of the present invention to provide a product that can be used to facilitate the separation, collection, and retention of both refuse for disposal and recyclable items for recycling. It is an object to provide a product that can be used in conjunction with existing standard sized waste baskets and refuse containers, eliminating the need for the consumer to purchase additional rigid containers and eliminating the need to find additional space within which to place the new containers.

It is a further object of the present invention to provide an inexpensive product that can be manufactured using existing bulk manufacturing equipment. It is an object of the present invention to provide a product that can itself be disposed of and/or recycled after use. Finally, it is an object of the present invention to provide a product that for the consumer is easy to dispense one at a time for use, easy to place in existing waste receptacles, and easy to remove, close, and separate for appropriate disposal/recycling.

In fulfillment of these and other objectives, the present invention provides an expandable multilayered plastic bag suitable for collecting and separately retaining both a quantity of refuse to be disposed of and a quantity of one or more types of recyclable items to be later recycled. The construction of the bag, despite its multiple compartments, lends itself to ease of manufacture on existing types of continuous sheet plastic bag manufacturing machinery. The multi-compartment bag provides two or more longitudinal compartments for the receipt of refuse or recycling. The longitudinal compartments are each sealed on three sides with a fourth (top) edge open to allow the insertion of the refuse or the recyclable items. The multi-compartment bag is initially constructed as a single unit and may be separated into the multiple components along one or more perforated mid-seams. The top (open) edge of the multi-component multi-compartment bag may include a captive draw string accessible through one or more apertures in the side of the bag near the upper edge. The optional captive draw string extends across each of the multiple compartments constructed in the bag and may, like the bag itself, be separated into individually usable draw strings for each of the separated bag components. Grab handles may also be formed near the upper edge by providing partial perforated cutouts in the manufacturing process.

The multi-compartment bag is designed to be used in standard single compartment waste basket or trash receptacle without the need for the consumer to purchase special multi-compartment rigid receptacles. When inserted into the standard trash receptacle, the bag may be opened and the upper edge may be drawn over and down the top rim of the trash receptacle as is known for single compartment trash bags and the like. In this manner the multiple compartments separated by the intermediate seams of the expanded bag are presented to receive and retain refuse (through one top opening) and recycling (in one or more additional top openings).

The construction of the bag lends itself to being manufactured in a continuous multilayer sheet with longitudinal sealed seams along each edge of the multilayered sheet and at least one partial longitudinal sealed seam along one or more mid-line(s) of the multilayered sheet. The optional draw string components and draw string captive cover components are positioned and adhered across the multilayered sheet adjacent to one or more cut access openings. The mid-line(s) along the interior partial longitudinal sealed seam(s) may be perforated for the later separation of the multiple bag components. Likewise, grab handle perforations (in the nature of a partial or complete ovals or circles) may be made at the appropriate intervals through the multilayered material. In this manner the bag of the present invention may be manufactured in a continuous sheet and may include separation cross-cut perforations that allow a large number of the bags to be packaged either on a roll or folded and stacked in a dispensing box container.

### BRIEF DESCRIPTION OF THE DRAWINGS

In the Drawing figures attached the various components of the present invention are labeled and referenced with the following consistent reference numbers, wherein the same reference numbers refer to the same or similar components on each of the Drawing figures.

FIG. 1 is a perspective view of a combination bag of the present invention configured in a collapsed form as it might be dispensed from a roll or a box ready for use.

FIG. 2 is a perspective view of the open and separated components of the combination bag of the present invention configured ready for closure and disposal (in the case of the refuse component) and for recycling (in the case of the recyclable component).

FIG. 3 is a side plan view of the combination bag of the present invention (as shown in FIGS. 1 & 2) demonstrating the manner in which the bag may be manufactured in a continuous multilayer sheet that is then sealed and cut in the manner shown.

FIG. 4 is a perspective view of the combination bag of the present invention shown positioned in place on a typical single compartment trash receptacle.

FIG. 5 is a perspective view of an alternate embodiment of the combination bag of the present invention configured in a collapsed form as it might be dispensed from a roll or a box ready for use.

FIG. 6 is a perspective view of the open and separated components of the alternate embodiment of the combination bag of the present invention configured ready for closure and disposal (in the case of the refuse component) and for recycling (in the case of the recyclable component).

FIG. 7 is a side plan view of the alternate embodiment of the combination bag of the present invention (as shown in FIGS. 5 & 6) demonstrating the manner in which the bag may be manufactured in a continuous multi-layer sheet that is then sealed and cut in the manner shown.

### DETAILED DESCRIPTION OF THE PREFERRED EMBODIMENTS

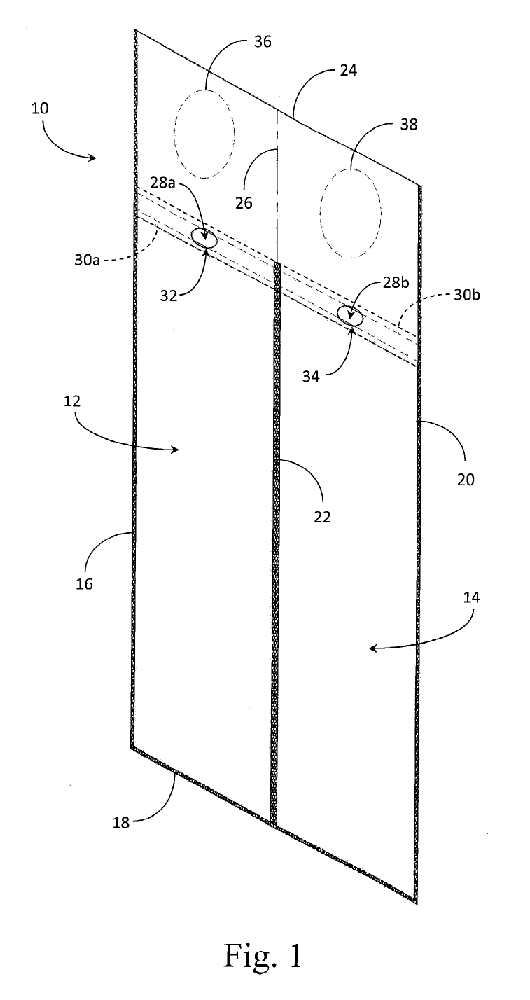

Reference is made first to FIG. 1 for a detailed description of the basic combination refuse/recycling bag of the present invention. FIG. 1 is a perspective view of one bag of the present invention as it may have been dispensed from its packaging and prepared for use in a waste basket or trash receptacle. Combination refuse/recycle bag 10 is a multilayered plastic bag constructed of polymer plastic sheets much in a manner similar to standard plastic trash bags. In the preferred embodiment shown, combination bag 10 is made up of a large bag component 12 and a small bag component 14. In the preferred embodiment large bag component 12 may best be used for recycling while small bag component 14 may best be used for refuse. The opposite (large bag for refuse and small bag for recycling) may be appropriate where greater quantities of refuse may be anticipated.

The overall combination bag 10 is sealed along sealed side seam 16, sealed cross seam 18, and sealed side seam 20. In addition, one or more sealed partial mid seams 22 are provided longitudinally through the midsection of the bag so as to separate the interior of the bag into multiple compartments. In the preferred embodiment shown in FIG. 1 there is a single sealed mid seam 22 that divides combination bag 10 into large bag component 12 and small bag component 14. With the above described sealed seams generally forming expandable pockets within bag 10, the open top edge 24 of the bag remains unsealed.

One goal of the present invention is the use of the bag 10 in a standard waste basket or refuse container and as such it is the intent of the structure of the bag to remain as a unitary bag when it is placed into and expanded within the standard waste basket. After such use, however, it is an object of the present invention to be able to separate the two bag components 12 & 14 one from the other such that they may be separately disposed of (or recycled as the case may be). To achieve this, one or more perforated separation line(s) 26 is established though the middle of sealed mid seam(s) 22 in a manner that keeps the new edges of the individual bag components sealed (i.e. the sealed seam is wide enough to be split lengthwise and remain sealed).

Integrated into the preferred embodiment of bag 10 as shown in the figures is a draw string member comprised of large bag draw string 28a and small bag draw string 28b. These draw string components are held captive in channels formed by sealing a draw string cover liner over the draw string components against the interior walls of the multilayer bag. Draw string cover liner in the preferred embodiment is comprised of large bag draw string liner 30a and small bag draw string liner 30b. Cut through the exterior walls of each bag component and positioned over the respective draw string are draw string openings 32 & 34 as shown. This manner of integrating a strong non-stretch plastic strip as a draw string in a multilayer plastic bag is known in the art.

Both the draw string and the associated cover liner are configured to be sealed and cut at the edges of the bag components as shown. In the case of the perforated mid seam 22 the separation of the bag components also achieves the separation of the draw string components. Each individual draw string component 28a & 28b may then be utilized to close off the respective bag that they are attached to.

Finally seen in FIG. 1 are cutout grab handle openings 36 & 38. These cutout openings extend through both layers of the multilayered bag so as to form two handles for each of the separated bag components. In the preferred embodiment, these openings 36 & 38 are partial circles or partial ovals such that the opening may be realized even though the cutout piece is not fully detached from the bag. Overall, the structure of bag 10 in part follows from the bulk manufacturing process which is described in more detail below. In general, however, every structural aspect of bag 10 is such as to be manufactured on automated machinery capable of producing a continuous sheet of bags connected end to end and cut through at the ends so as to retain the bottom sealed seam 18 and open the top edge 24.

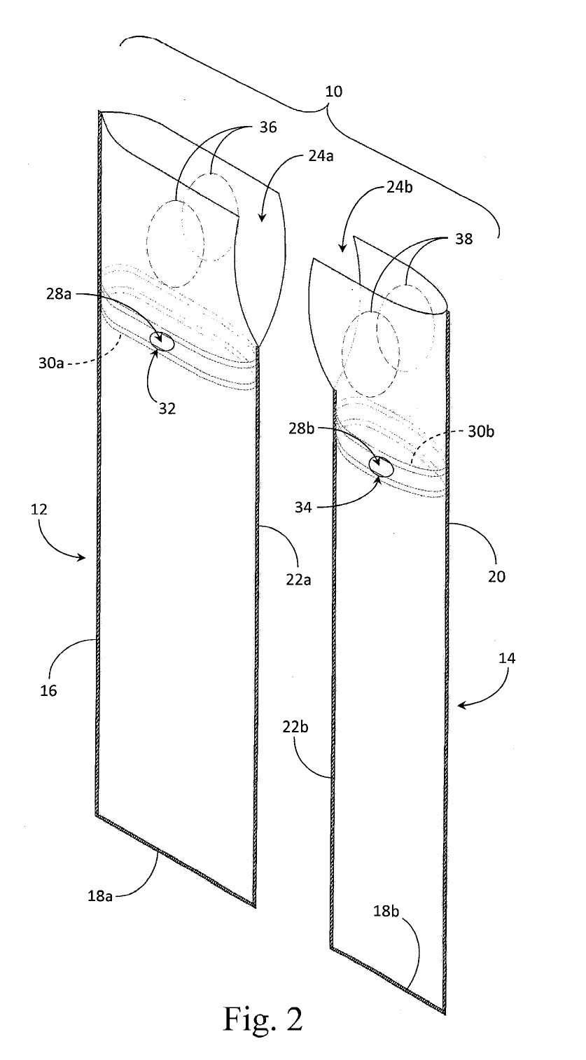

Reference is now made to FIG. 2 for a description of the manner in which the bag components 12 & 14 may be separated one from the other as briefly described above. In this view, bag component 12 is separated from bag component 14 along the perforated separation line (no longer shown) so as to form sealed large bag cross seam 18a and sealed small bag cross seam 18b. In addition, mid seam 22 is now replaced by the separated sealed large bag mid seam 22a and sealed small bag mid seam 22b. Likewise, draw string 28 has now been separated into large bag draw string 28a and small bag draw string 28b. Top opening 24 is now comprised of large bag top opening 24a and small bag top opening 24b. In this view it can be further seen how grab handle openings 36 & 38 actually form two handles each, one through each layer of the two layer bag components.

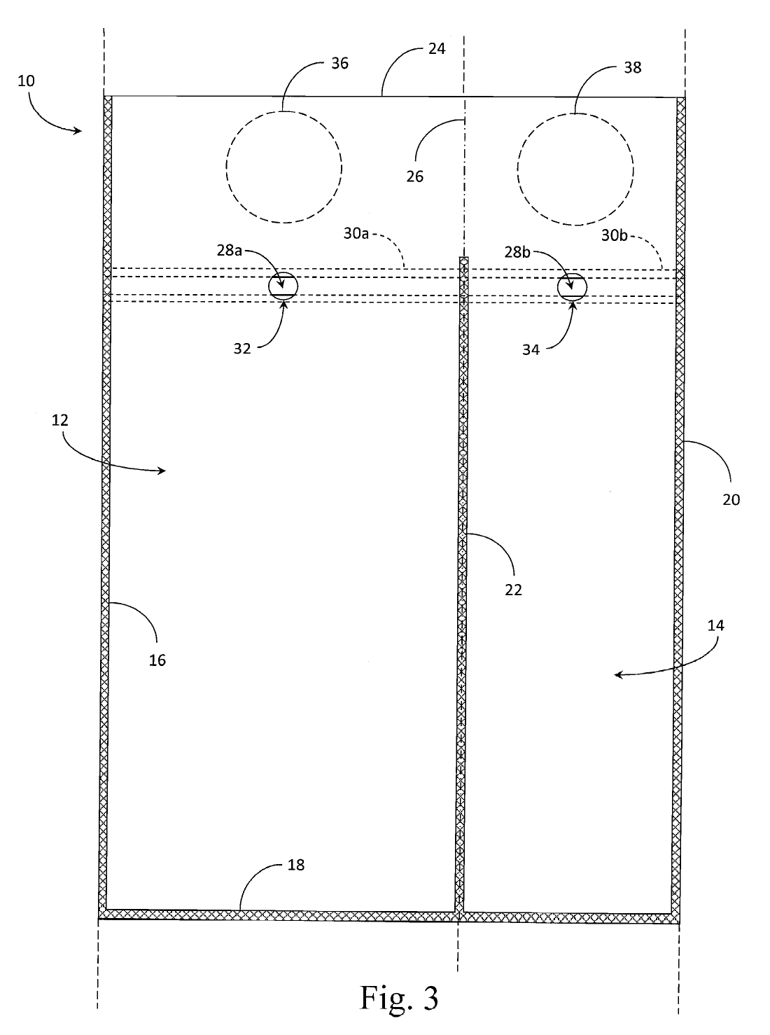

FIG. 3 provides additional detail on the size and structure of the combination bag 10 and indicates the manner in which the bags may be manufactured in a continuous linear multilayered sheet. As indicated above, it is one object of the present invention that it be used in conjunction with existing waste baskets and trash receptacles. It is envisioned therefore that there may easily be combination bags constructed according to the design described herein that are of a multitude of different sizes. What is described herein below is but one example of the dimensions of a typical combination bag utilized in conjunction with a standard kitchen sized garbage container. Those skilled in the art will recognize that these dimensions may be scaled up or down as necessary.

In general terms, combination bag 10 may have an overall length (distance from sealed cross seam 18 to top edge 24 of the standard garbage bag length plus 8″-10″ extra. This extra length is made up of the top section of the bag above the draw string. The distance from the draw string to the bottom edge (sealed cross seam 18) is approximately the length of a standard sized garbage bag (for the same sized container). The overall width of the combination bag is preferably about 120% of the width of the standard sized garbage bag (for the same sized container). This width is split, in the preferred embodiment shown, into 60% for the large bag component 12 and 40% for the small bag component 14.

As mentioned above, the draw string (which may be the standard 1″ wide plastic strip) is positioned about 8″-10″ from the top edge 24. Draw string openings 32 & 34 are slightly larger than the flattened draw string sections 28a & 28b so as to allow easy access to the draw string. A corresponding opening is formed on the opposite side of the bag component as described below. Grab handle openings 36 & 38 will, in the preferred embodiment, be constructed with partially cutout 3″ radius circles.

The seams about the edges of the combination bag (seams 16, 18, & 20) should be approximately ¼ inch in width. Sealed mid seam 22 should therefore be approximately ½ inch in width to accommodate being split as described above. At least ½ inch of sealed mid seam 22 should extend above the draw string cover liner 30 to prevent the separation of the bag components from inadvertently exposing the draw string when pulled apart.

Each of the structural features of combination bag 10 is designed to be manufactured using existing continuous multilayered sheet plastic bag manufacturing machinery. In general the production of the bag progresses from cutting the draw string apertures to placement of the draw string cross strips (two) to the placement of the draw string cover liner strips (also two), on each of the two interior faces of the multilayer bag. The draw string placement may generally be achieved by the insertion of a stacked multilayered strip comprising a first draw string strip, a first liner strip, a second liner strip, and finally a second draw string strip. Once these components are in place on the interior, the two layers are brought together and sealed along the seam lines as shown and described. The edge sealed seams are continuous while the mid sealed seams are interrupted as shown and described. The sealing process may then be followed by a perforation process that establishes the perforated separation line 26 and the partial cutouts 36 & 38 (extending through both layers of the bag walls). In the sealing process the draw string ends are held captive within the sealed seams.

Finally in the manufacturing process, cross seam 18 is sealed and the bag is either cut from the next bag in line or a perforated tear line is established between the bags. If the bags are to be dispensed on a roll a perforated tear line may be preferred. If the bags are to be packed in and dispensed from a box it may be preferred to cut the bags apart. In either case, it is typical to fold the flat continuous sheet bags one or more times across their widths (a process known in the art) before creating a perforated tear line or cutting the bags apart. In the above described manner, although there are many unique features to the bag design of the present invention, it may still be manufactured using existing high speed continuous feed machinery with standard cross feed components and linear and cross feed sealing and perforating.

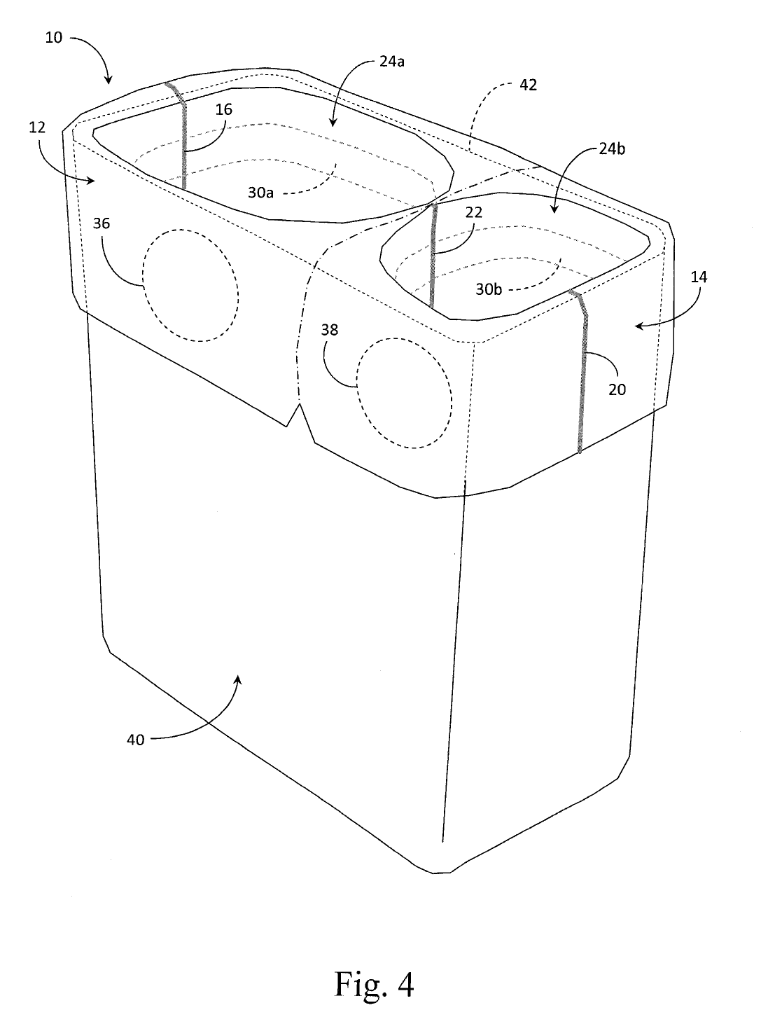

Reference is next made to FIG. 4 for a description of the manner in which the combination bag 10 of the present invention may be utilized in conjunction with a standard sized single compartment trash container 40. In the example shown, trash container 40 may be a standard sized kitchen garbage receptacle having a single top opening defined by top rim 42 (shown in dashed outline in FIG. 4). In this view it may be seen how the extra width dimension of the combination bag 10 of the present invention serves to facilitate the opening of the bag compartments through open top edges 24a & 24b. The extra length given to the bag of the present invention facilitates turning the top portion of the bag (the section above the draw string) out and down around the rim 42 of the trash receptacle 40. It can be seen in this view how mid seam 22 establishes the division between bag component 12 and bag component 14 within the confines of trash receptacle 40. The result is two separate bag components ready to receive and maintain separated, both recycling on one side (within bag component 12 for example) and refuse (within bag component 14 for example).

When full, the bags components 12 & 14 may be removed from trash receptacle 40, closed with their respective draw strings, and then separated one from the other along perforated separation line 26 as described above. Grab handles 36 & 38 facilitate both the removal of the full bags from the trash container 40 and the handling of the bag components after separation and closure.

### DETAILED DESCRIPTION OF AN ALTERNATE PREFERRED EMBODIMENT

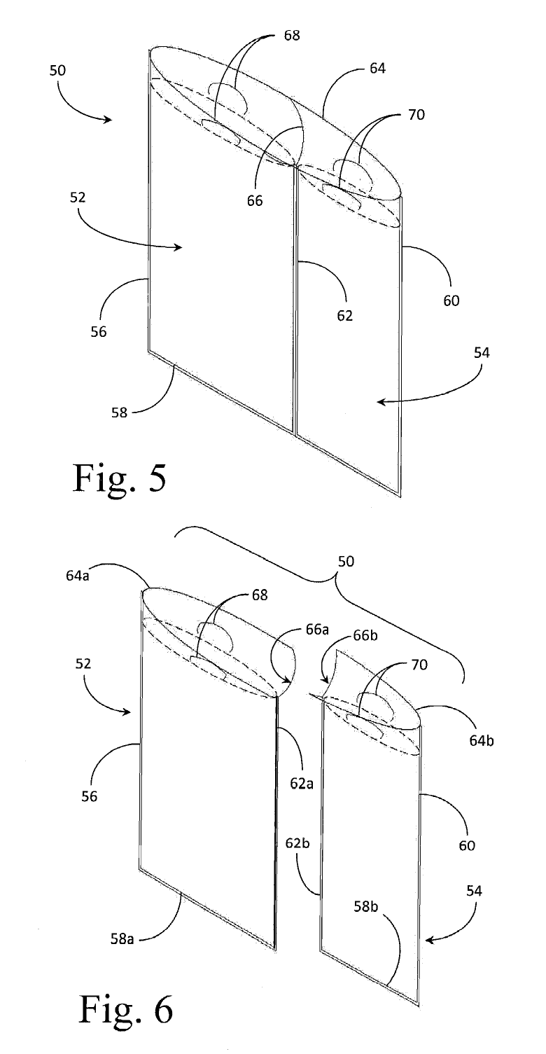

Reference is now made to FIG. 5 for a detailed description of an alternate preferred embodiment of the combination refuse/recycling bag of the present invention. FIG. 5 is a perspective view of one bag of the present invention as it may have been dispensed from its packaging and prepared for use in a waste basket or trash receptacle. In the alternate embodiment shown, combination bag 50 is made up of a large bag component 52 and a small bag component 14. In the preferred alternate embodiment, large bag component 52 may best be used for recycling, while small bag component 54 may best be used for refuse. Once again the opposite (large bag for refuse and small bag for recycling) may be appropriate where greater quantities of refuse may be anticipated. In this alternate preferred embodiment, as in the initial embodiment described above, the ratio in size of the large bag to the small bag may preferably be on the order of 60% to 40% or 70% to 30% as the specific requirements might dictate.

Combination bag 50 is sealed along sealed side seam 56, sealed cross seam 58, and sealed side seam 60. In addition, one or more sealed partial mid-seams 62 are provided longitudinally through the mid-section of the bag so as to separate the interior of the bag into multiple components. In the alternate embodiment shown in FIG. 5, there is a single sealed mid-seam 62 that divides combination bag 50 into large bag component 52 and small bag component 54. With the above described sealed seams generally forming expandable pockets within bag 50, the open top edge 64 of the bag remains unsealed as shown.

To achieve the separation of the two bag components 52 and 54 one from the other, one or more perforated separation lines 66 is established through the middle of sealed mid-seam(s) 62 in a manner that keeps the new edges of the individual bag components sealed (i.e., the sealed seam is wide enough to be split lengthwise and remain sealed).

The alternate preferred embodiment shown in FIG. 5 (as well as in FIGS. 6 & 7) differs from the initially described preferred embodiment primarily in the absence of the drawstring component. The embodiment shown in FIG. 5 lends itself to manufacturing advantages not found in the previously described preferred embodiment of the present invention. As shown in FIG. 5 the upper portion of each of the bag components may be separately cut or perforated to provide an opening that is not sealed on an interior edge 62. Cut out grab handle openings 68 and 70 are shown positioned near the upper top edge 64. These cut out grab handle openings comprising partial ovals cut as perforated openings extending through both layers of the multi-layer bag so as to form two handles for each of the separated bag components. In the alternate embodiment shown, these openings 68 and 70 are partial ovals such that the opening may be realized even though the cut out piece is not fully detached from the bag. Once again, it is one object of the alternate embodiment of the present invention to be manufactured on automated machinery capable of producing a continuous sheet of bags connected end-to-end and cut through at the end so as to retain the bottom seal seam 58 and to create the open top edge 64.

Reference is now made to FIG. 6 for a description of the manner in which the bag components 52 and 54 may be separated one from the other as briefly described above. In this view, bag component 52 is separated from bag component 54 along the perforated separation line (no longer shown) so as to form sealed large bag cross-seam 58a and sealed small bag cross-seam 58b. In addition, mid-seam 52 is now replaced by the sealed large bag mid-seam 62a and sealed small bag mid-seam 62b. Likewise, top opening 64 is now comprised of large bag top opening 64a and small bag top opening 64b. In this view it can be further seen how grab handle openings 68 and 70 actually form two handles each, one through each layer of the two layer bag components.

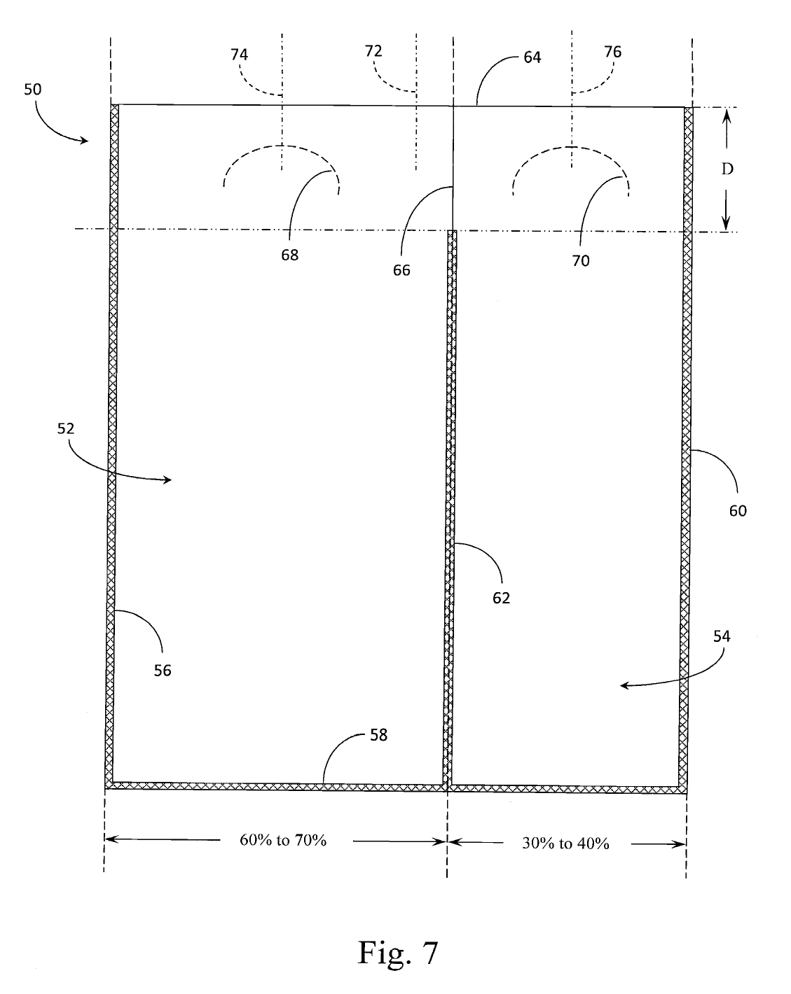

Reference is finally made to FIG. 7 for additional detail on the size and structure of the alternate preferred embodiment of the combination bag 50 of the present invention. This figure alludes to the manner in which the bag may be manufactured in a continuous linear multi-layered sheet. As indicated above, it is one object of the present invention that it be used in conjunction with existing trash receptacles and waste baskets. It is envisioned therefore that there may easily be combination bags constructed according to the designs described herein that are a multitude of different sizes. What is described herein in conjunction with the alternate preferred embodiment of the present invention is but one example of the dimensions of a typical combination bag utilized in conjunction with a standard kitchen-sized garbage container. Those skilled in the art will again recognize that these dimensions for the alternate embodiment may be scaled up or down as necessary.

In general terms, combination bag 50 may have any overall length (distance from sealed cross-seam 58 to top edge 64) of the standard garbage bag length plus 8″-10″ extra. This extra length is made up of the top section of the bag which extends above the end of the mid-seam 62. The overall width of the alternate embodiment combination bag is preferably about 120% of the width of the standard sized garbage bag (for the same sized container). This width is preferably split in the alternate embodiment shown into 60% (or 70%) for the large bag component 52 and 40% (or 30%) for the small bag component 54. The various seams and other components of the alternate embodiment shown in FIGS. 5-7 are similar in geometry and configuration to the seams described above in conjunction with the first preferred embodiment. Each of the structural features of the combination bag 50 is designed to be manufactured using existing continuous multi-layered sheet plastic bag manufacturing machinery. Elimination of the draw string component in the alternate embodiment greatly simplifies the manufacturing process and provides for a more economical combination bag while still providing for the same bag volume and versatility. The manufacturing process described above in conjunction with the first preferred embodiment remains generally the same in conjunction with the alternate embodiment without, of course, the need to establish the draw string and the various seams and cut outs associated therewith.

Various features that may typically be associated with the variety of standard trash bags are anticipated as capable of being incorporated with the combination bag of the present invention. These features include variation in plastic sheet thicknesses for different environments (and different types of recyclable materials), variations in bag color for different environments and applications, and of course, variations in the number of bag components constructed into the unitary combination bag. It is further anticipated that a variety of visual cues may be integrated into the bag construction to remind the user which of the multiple bag components are intended for which purpose (refuse or recycling). Although the initial choice of which bag component to use to refuse and which for recycling is not so important, it is of course important that there be consistent use of the same side for the same purpose. It may therefore be important to provide visual cues to distinguish the bag components. Perhaps the simplest and most useful mechanism for providing this visual cue is to provide two distinct colors of draw string. Each draw string band or strip used in the cross construction of the bag may be alternately colored green and red. In this manner, the larger bag may end up with a green draw string (indicating recycling) visible through the access aperture, while the smaller bag may have a red draw string (indicating refuse) visible. Various other mechanisms for providing visual cues to distinguish the bag components from each other during use are anticipated.

Although the present invention has been described in terms of the foregoing preferred embodiments, this description has been provided by way of explanation only, and is not intended to be construed as a limitation of the invention. Those skilled in the art will recognize modifications of the present invention that might accommodate specific refuse and recycling environments and requirements. Those skilled in the art will further recognize additional means for constructing alternative bag shapes and sizes, with or without many of the secondary features of the preferred embodiments of the present invention. Such modifications, as to structure, orientation, geometry, and even composition and construction techniques, where such modifications are coincidental to the type of refuse or recycling application, do not necessarily depart from the spirit and scope of the invention. Although the preferred embodiments shown and described comprise a two component combination bag, it is anticipated that a three component combination bag may be as practical to manufacture and as practical in use. While further multiples of component bags are anticipated the two and three component combination bags will most likely be the most useful embodiments.

We claim:

1. A multi-compartment bag for collecting and separately retaining both a quantity of disposable refuse and a quantity of one or more types of recyclable items, the multi-compartment bag comprising:
a generally rectangular, multi-layered sheet of material having a length and a width, the multiple layers sealed together along first and second longitudinal edges of the multi-layered sheet, and along a bottom transverse edge of the multi-layered sheet, the multiple layers remaining open along a top edge of the multi-layered sheet so as to form at least one enclosure between the multiple layers;
the multiple layers further at least partially sealed together along a mid-seam extending longitudinally on the multi-layered sheet between and generally parallel to the sealed first and second longitudinal edges;
the mid-seam further is longitudinally perforated so as to permit the separation of the multi-compartment bag into at least two separate single compartment bags.

2. The multi-compartment bag of claim 1 wherein the multiple layers further are partially perforated in at least one location proximate to the top edge of the multi-layered sheet so as to allow for the formation of handle apertures through the multiple layers.

3. The multi-compartment bag of claim 1 further comprising a multi-part drawstring integrated into the multiple layers along a transverse line across the width of the bag at a position proximate to the top edge of the multi-layered sheet, the multiple layers further defining a plurality of drawstring apertures through which the multi-part drawstring may be accessed.

4. The multi-compartment bag of claim 2 further comprising a multi-part drawstring integrated into the multiple layers along a transverse line across the width of the bag at a position proximate to the top edge of the multi-layered sheet but further from the top edge than the handle apertures, the multiple layers further defining a plurality of drawstring apertures through which the multi-part drawstring may be accessed.

5. The multi-compartment bag of claim 1 wherein the mid-seam is unevenly positioned across the width of the bag so as to divide the bag into a large single compartment bag and a small single compartment bag.

6. The multi-compartment bag of claim 5 wherein the large single compartment bag comprises a percentage of the overall bag in the range of 55% to 65% inclusive.

7. The multi-compartment bag of claim 5 wherein the large single compartment bag comprises a percentage of the overall bag in the range of 65% to 75% inclusive.

8. The multi-compartment bag of claim 1 wherein the multi-layered sheet of material comprises plastic material.

9. The multi-compartment bag of claim 8 wherein the plastic material comprises polyethylene material.

10. A method for manufacturing a multi-compartment bag comprising the steps of:
providing a generally rectangular, multi-layered sheet of material having a length and a width;
sealing the multiple layers together along first and second longitudinal edges of the multi-layered sheet;
sealing the multiple layers together along a bottom transverse edge of the multi-layered sheet, the multiple layers remaining open along a top edge of the multi-layered sheet so as to form at least one enclosure between the multiple layers;
at least partially sealing the multiple layers together along a mid-seam extending longitudinally on the multi-layered sheet between and generally parallel to the sealed first and second longitudinal edges; and
longitudinally perforating the sealed mid-seam so as to permit the separation of the multi-compartment bag into at least two separate single compartment bags.

11. The method of claim 10 further comprising the step of at least partially perforating the multi-layered sheet in at least one location proximate to the top edge so as to allow for the formation of handle apertures through the multiple layers.

12. The method of claim 10 further comprising the step of integrating a multi-part drawstring into the multiple layers along a transverse line across the width of the bag at a position proximate to the top edge of the multi-layered sheet, and cutting a plurality of drawstring apertures through the multi-layered sheet through which the multi-part drawstring may be accessed.

13. The method of claim 1 wherein a plurality of multi-compartment bags are manufactured end to end and the method further comprises perforating the junction between each multi-compartment bag along the sealed bottom transverse edge.

14. The method of claim 13 wherein the plurality of multi-compartment bags manufactured are assembled into a roll for subsequent dispensing of each multi-compartment bag one at a time by tearing at the perforated junction between each multi-compartment bag.
